(19) United States
(12) Patent Application Publication
(10) Pub. No.: US 2018/0326915 A1
(43) Pub. Date: Nov. 15, 2018

(54) LOAD SUPPORT SYSTEM FOR VEHICLE ROOF

(71) Applicant: HORIZON GLOBAL AMERICAS INC., Plymouth, MI (US)

(72) Inventor: Martin Ian DICKINSON, Northampton (GB)

(21) Appl. No.: 15/770,776

(22) PCT Filed: Oct. 27, 2016
(86) PCT No.: PCT/US16/58974

§ 371 Date: Apr. 25, 2018

Related U.S. Application Data
(60) Provisional application No. 62/246,802, filed on Oct. 27, 2015.

(51) Int. Cl. B60R 9/045

(52) U.S. Cl. CPC B60R 9/045

(57) ABSTRACT

Provided is a modular roof rack assembly configured to be selectively attached to a vehicle as shown and described. The roof rack assembly includes modular opposing rail members configured to attach to at least one cross bar therebetween. The opposing rail members may include an external portion and an internal portion wherein the internal portion may be configured to be received by the external portion. The internal portion may be an insert and the external portion may be an extruded member. The rail members may include an internal track accessible between the opposing rail members. The inserts may include a profile having a plurality of detents shaped to receive an end portion of the cross beam to be supported between the opposing rail members. At least one of the cross bars may be configured to be selectively attached to tracks.

### CROSS REFERENCE TO RELATED APPLICATIONS

This application claims the benefit of and priority to U.S. Provisional Patent Application Ser. No. 62/246,802, filed on Oct. 27, 2015 and incorporated by reference as if fully rewritten herein.

### FIELD OF INVENTION

The present invention is generally related to a load support system for a vehicle roof and, more particularly, to a roof rack assembly configured to simplify coupling the rack on a vehicle roof.

### BACKGROUND

Roof rack assemblies are a common way cargo is stowed on a vehicle during travel. It has become common place to use the roof of a vehicle to stow items that do not fit inside the vehicle. There are many different types of roof racks available that are used on many different types of vehicles, such as mini-vans, sport utility vehicle, cars, trucks, and the like.

One known type of vehicle roof rack assembly is a rack having a one-piece, fully preassembled body. These types are configured to be attached to the roof of the vehicle in an “as is” state. The one piece body is often made of welded steel or aluminum and is usually large, bulky, and heavy, and this type of roof rack assembly may be difficult to assemble, transport or store when not installed on the roof of the vehicle. Additionally, these assemblies generally lack the ability to be customizable to fit to various sized roofs, they may be difficult to manufacture, and would require the assistance of others to install.

Another iteration of such preassembled roof racks involve the type in which a single piece, square or rectangular metal frame is provided, with removable and/or adjustable cross bars inserted along an interior facing of the frame. While this arrangement provides customers with some ability to select the positioning of the rails, the bulky frame itself still presents many of the problems noted above with respect to fully preassembled roof racks. FIG. 2 illustrates a prior art welded metal frame roof rack MF.

Still other known roof rack assemblies are sold in component form. This arrangement eliminates the bulkiness of the heavy, one-piece types by providing the rack as a series of prefabricated sections. The sections must be fitted together on top of the vehicle and usually include an excess number of fasteners to properly attach together the individual members to the roof rack. As such, these systems can be more difficult and time consuming to assemble and fit to the vehicle, with significantly increased likelihood for error during customer installations. The prefabricated sections themselves also still possess an awkward flat, planar, rectangular shape, which may present challenges in shipping the unassembled pieces. Also, installations are not truly customizable and, instead, are limited (but to a lesser degree in comparison to fully preassembled racks) by the size of the component sections. Finally, the use of discrete sections and fasteners increases the number of parts and the possibility that any one of these elements may be defective and/or fail, thereby presenting increased risks with respect to maintenance.

Ultimately, existing designs add complexity and difficulties in shipping and installation, all of which may increase cost and maintenance requirements. Further, these features may not sufficiently address wind resistance caused by outdoor vehicle travel or provide customers with sufficient, customized equipment to meet the needs of their specific vehicles.

### SUMMARY

Provided is a roof rack assembly configured to be selectively attached to a vehicle as shown and described. The roof rack assembly includes first and second modular rail members aligned and opposed with one another. The rail members may be configured to attach to at least one cross bar therebetween. The opposing rail members may include an external portion and an internal portion wherein the external portion may be configured to receive the internal portion. The internal portion may be a modular insert and the external portion may be a modular extruded member. The rail members may include an internal track accessible between the opposing rail members. The inserts may include a profile having a plurality of detents shaped to receive an end of the cross beam to be supported between the opposing rail members.

At least one cross bars may be configured to extend between the opposing rail members and be selectively attached to the internal track. At least one cross bar may include a foot attachment member configured to support the cross bar to the vehicle.

Accordingly, the disclosed roof rack assembly may solve the problems that exist in the prior art and may be utilized for stowing cargo during travel, while at the same time providing solutions to the problems known in the art.

In one aspect, a roof rack may comprise any combination of the following:
a first rail having an external facing, an internal facing having a series of detents formed thereon, and an internal track;
a second rail, spaced apart from the first rail, having an external facing, an internal facing having a series of detents formed thereon, and an internal track;
a cross bar having first and second ends, wherein the first end cooperates with one of the detents and the internal track of the first rail and the second end cooperates with one of the detents and the internal track of the second rail to secure the cross bar between the first rail and the second rail;
a foot attachment member associated with the cross bar, wherein a top portion of the foot attachment member receives a portion of the cross bar at a point between the first and second ends;
a coupling positioned between a pair of adjacent modular sections of at least one of: the first rail and the second rail;
a biasing member positioned proximate to each detent;
at least one accessory received within the internal track of the first rail;
cross bar attachment members disposed at the first and second ends of at least one cross bar;
at least one end cap positioned on corresponding ends of the first rail and the second rail;
wherein the first rail further comprises a plurality of modular sections, each modular section of the first rail having an internal facing with a portion of the detents and a portion of the internal track formed thereon;
wherein the second rail further comprises a plurality of modular sections, each modular section of the second rail having an internal facing with a portion of the detents and a portion of the internal track formed thereon;
wherein the coupling includes at least one: a tongue, an aperture, a channel, a snap-fit member, and a peg;
wherein the coupling is integrated into the pair modular sections of at least one of: the first rail and the second rail;
wherein at least one of the detents includes a nodule;
wherein a plurality of cross bars are provided and each cross bar is secured to the first rail and the second rail at a plurality of individual detents on each of the first rail and the second rail;
wherein the at least one accessory comprises an eyelet;
wherein cross bar attachment members are disposed on the first and second ends of all of the cross bars;
wherein at least one of the cross bar attachment members includes a protrusion received within the internal track of at least one of the first rail and the second rail;
wherein at least one of the cross bar attachment members further includes a fastener;
wherein the fastener passes through the first end of the cross bar and is received by the protrusion;
wherein the cross bar attachment members comprise individual retainers fitted into individual detents on at least one of the first rail and the second rail;
wherein a plurality of end caps secure a third cross bar positioned between the first rail and the second rail;
wherein the end caps are provided at both ends of each of the first rail and the second rail;
a second coupling is positioned between at least one end cap and at least one of the first rail and the second rail;
wherein the second coupling includes at least one: a tongue, an aperture, a channel, a snap-fit member, and a peg;
wherein a plurality of second couplings are associated with each end cap;
wherein the foot attachment member comprises a sleeve; and
wherein a pair of foot attachment members are provided to two separate cross bars, each of the two separate cross bars having first and second ends so that the first end cooperates with one of the detents and the internal track of the first rail and the second end cooperates with one of the detents and the internal track of the second rail to connect to the second rail to secure each cross bar between the first rail and the second rail at spaced apart locations.

In a further aspect, a method of attaching a roof rack to a vehicle may comprise any combination of the following:
attaching a pair of foot attachment members to two separate cross bars;
securing the foot attachment members to a vehicle rooftop;
coupling together modular sections to form a first rail having a series of detents and an internal track and second rail having a series of detents and an internal track;
connecting the first rail to the two separate cross bars by positioning an end of each cross bar within separate detents on the first rail;
connecting the second rail to the two separate cross bars by positioning an opposing end of each cross bar within separate detents on the second rail
attaching a cross bar attachment members to opposing ends of each cross bar and fitting each cross bar attachment member within the internal tracks on both the first and second rails; and
attaching end caps to corresponding ends of the first and second rail and securing a third cross bar between the end caps.

### DESCRIPTION OF THE DRAWINGS

Operation of the invention may be better understood by reference to the following detailed description taken in connection with the following illustrations, wherein:

FIG. 1 is a perspective view of an embodiment of a roof rack assembly in accordance with the disclosure;

FIG. 2 is a perspective view a fully preassembled roof rack assembly according to the prior art;

FIG. 3 is a perspective view an embodiment of a rail member of the roof rack assembly of FIG. 1;

FIG. 4 is a perspective view an embodiment of a rail member of the roof rack assembly of FIG. 1;

FIG. 5 is a partial perspective view a front portion of the rail member of the roof rack assembly of FIG. 1;

FIG. 6 is a partial perspective view of a rear portion of the rail member of the roof rack assembly of FIG. 1;

FIG. 7 is a partial perspective view of a base cross bar attached to a track of the rail member of the roof rack assembly of FIG. 1;

FIG. 8 is a perspective view of an attachment member of the base cross bar of the roof rack assembly of FIG. 1;

FIG. 9 is a partial perspective see-through view of the base cross bar attached to the rail member of the roof rack assembly of FIG. 1;

FIG. 10 is a partial perspective view of a support cross bar attached to an insert of the rail member of the roof rack assembly of FIG. 1;

FIG. 11 is a front view of the insert of the rail member of the roof rack assembly of FIG. 1;

FIG. 12 is a partial perspective view of an eye hook attached to the track of the rail member of the roof rack assembly of FIG. 1;

FIG. 13 is a partial perspective view of embodiments of a base cross bar and foot attachment according to the present disclosure;

FIG. 14 is a partial perspective view of embodiments of the base cross bar and foot attachment with a load stop according to the present disclosure;

FIG. 15 is a perspective view of embodiments of the roof rack assembly in accordance with the disclosure;

FIG. 16 is a perspective view a base cross bar and foot attachments of the roof rack assembly in accordance with the disclosure;

FIG. 17 is a perspective view of a sleeve member of the foot attachment for the cross bar of the roof rack assembly of FIG. 16;

FIG. 18 is a perspective view of a panel member of the foot attachment for the cross bar of the roof rack assembly of FIG. 16;

FIG. 19 is a perspective view of the panel member of the foot attachment in an open position relative to the sleeve member for the cross bar in accordance with the disclosure;

FIG. 20 is a cross sectional view of the panel member of the foot attachment in the open position relative to the sleeve member for the cross bar in accordance with the disclosure;

FIG. 21 is a bottom perspective view of the panel member of the foot attachment in the open position relative to the sleeve member for the cross bar in accordance with the disclosure;

FIG. 22 is a bottom perspective view of the panel member of the foot attachment in a closed position relative to the sleeve member for the cross bar in accordance with the disclosure;

FIG. 23 is a perspective view of the panel member of the foot attachment in the closed position relative to the sleeve member for the cross bar in accordance with the disclosure;

FIG. 24 is a perspective view an embodiment of the rail member of the roof rack assembly of FIG. 15;

FIG. 25 is an enlarged partial perspective view the rail member of FIG. 24;

FIG. 26 is an exploded perspective view of modular members of the rail member of the roof rack assembly of FIG. 15;

FIG. 27A is an enlarged perspective view of a connector aligned between modular members of the rail member of the roof rack assembly of FIG. 26;

FIG. 27B is an enlarged perspective view of the connector attached between modular members of the rail member of the roof rack assembly of FIG. 26;

FIG. 28 is a partial perspective view of embodiments of the cross bar attached to the track of the rail member of the roof rack assembly of FIG. 15;

FIG. 29 is a perspective view of embodiments of the attachment member of the cross bar of the roof rack assembly of FIG. 15;

FIG. 30 is a perspective view of embodiments of the attachment member of the cross bar of the roof rack assembly of FIG. 15;

FIG. 31 is a perspective view of embodiments of a bar fastener of the attachment member of the cross bar of the roof rack assembly of FIG. 15;

FIG. 32 is a perspective view of embodiments of the attachment member of the cross bar of the roof rack assembly of FIG. 15;

FIG. 33A is a perspective view of embodiments of a rear cap of the roof rack assembly of FIG. 15;

FIG. 33B is a partial perspective view of a rear portion of the rail member of the roof rack assembly of FIG. 15;

FIG. 34A is a perspective view of embodiments of a front cap of the roof rack assembly of FIG. 15;

FIG. 34B is a partial perspective view of a front portion of the rail member of the roof rack assembly of FIG. 15;

FIG. 35 is a partial perspective view of a first cross bar attached to the tract and a second cross bar attached to the insert of the roof rack assembly of FIG. 15

FIG. 36A is a partial perspective view of the second cross bar attached to the insert of the roof rack assembly of FIG. 15;

FIG. 36B is a partial front view of the insert of the rail member of the roof rack assembly of FIG. 15;

FIG. 36C is a perspective view of a stop member for the insert of the rail member of the roof rack assembly of FIG. 15;

FIG. 37A is a perspective cross sectional view of the second cross bar attached to the insert of the roof rack assembly of FIG. 15;

FIG. 37B is a partial perspective view of the second cross bar attached to the insert of the roof rack assembly of FIG. 15;

FIG. 38A is a perspective view of the inserts of the modular members of the rail members of the roof rack assembly of FIG. 15; and

FIG. 38B is a partial see-through view of the inserts of the modular members of the rail members of the roof rack assembly of FIG. 15.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

Understanding that roof racks typical comprise two load-bearing bars that are oriented parallel (or roughly parallel) to one another, use of the term “internal” and “interior” may be synonymous with inner-facing portions of those bars (i.e., arranged toward one another), while “external” and “exterior” may indicate the opposing, outer-facing sides. Of course, common sense and context should be used in interpreting these and other terms found in this specification.

Also, while the modular nature of the embodiments described herein may require fastening mechanisms, it will be understood that certain aspects allow for the fastening mechanisms to be integrated with and provided as part of the modular components. Therefore, although embodiments described herein may require assembly, the overall customer experience will still be improved in comparison to the aforementioned prior art assemblies.

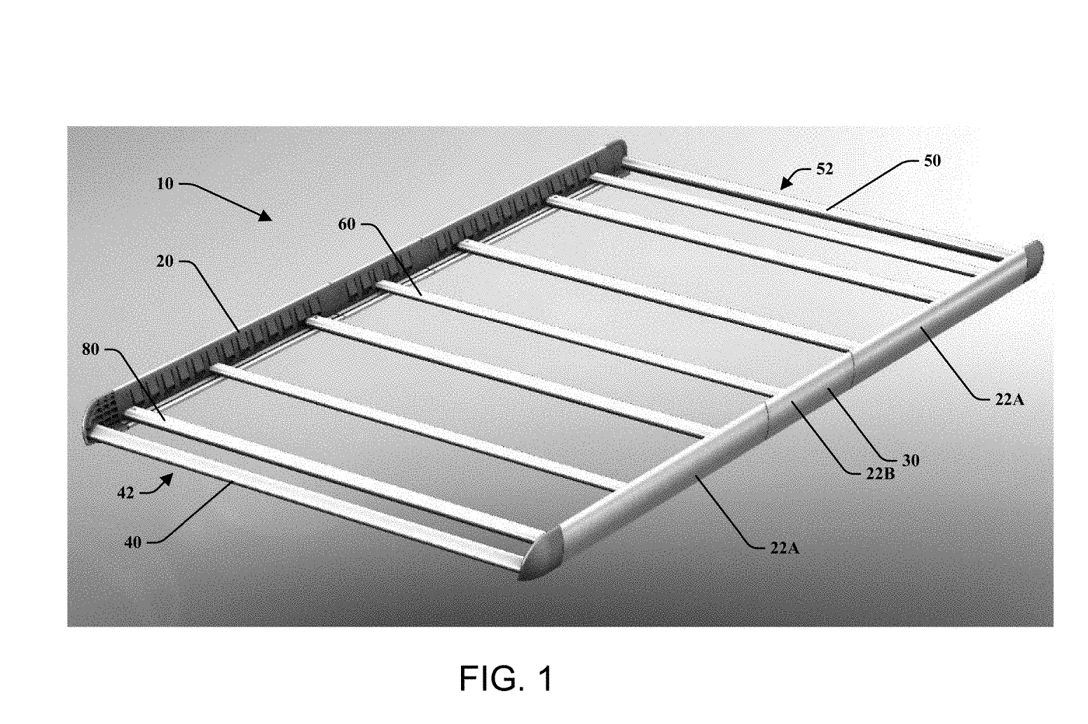

As illustrated by FIGS. 1 and 3-14, provided is an embodiment of a roof rack assembly 10 that is configured to be selectively attached to a vehicle. The roof rack assembly 10 includes a generally modular configuration that is easy to transport and store separate from the vehicle and efficient to customize and assemble to the vehicle as will be described below.

The roof rack assembly 10 includes a first rail member 20 and an opposing second rail member 30. The first rail member 20 may be generally aligned with the second rail member 30 and be customizable in various configurations. The first and second rail members 20, 30 may be spaced apart from one another in a generally parallel orientation. The rail members may be generally elongated and made from various materials included polymers, metals, or alloys. In one embodiment, the rail members are made from extruded metal, such as aluminum along with a molded plastic or rubber insert that will be described below. In other embodiments, the rail members may be a polymer (or any kind of plastic or rubber) and the insert or inserts may be formed from a metal such as aluminum. It should be understood, however, that any configuration is conceivable and that for the sake of brevity not every combination is disclosed, but the present teachings do contemplate any combination of materials.

The first and second rail members 20, 30 may have a common length to one another. Additionally, the first and second rail members 20, 30 may each have a modular configuration wherein each rail member includes at least one modular member configured to be attached in alignment.

A front cross bar 40 may extend between the rail members 20, 30 along a front portion 42 and a rear cross bar 50 may extend between the rail members 20, 30 along a rear portion 52. As illustrated by FIG. 1, the roof rack assembly 10 may include a length from the front portion 42 to the rear portion 52 that is between about 1 meter to about 5 meters or between about 2 meters to 4 meters or more particularly about 2.8 meters. The roof rack assembly 10 may include a width from the first rail member 20 to the second rail member 30 that is between about 3 feet to about 15 feet or between about 5 feet to 10 feet or more particularly be about 5 feet.

The roof rack assembly 10 is configurable to include at least one support cross bar 60 to extend from the first rail member 20 to the second rail member 30 and at least one base cross bar 80 to extend from the first rail member 20 to the second rail member 30. Notably, the support cross bars 60 may be configured to support cargo on the roof rack assembly 10 and the base cross bars 80 may be configured to attach the roof rack assembly 10 to the vehicle. There may be a plurality of support cross bars 60 that support the cargo load to space the cargo from the roof of the vehicle. The support cross bars 60 and base cross bars 80 may be attachable to the rail members 20, 30 in various ways, including, without limitation through fastening, snap fitting, adhering, friction fit, etc.

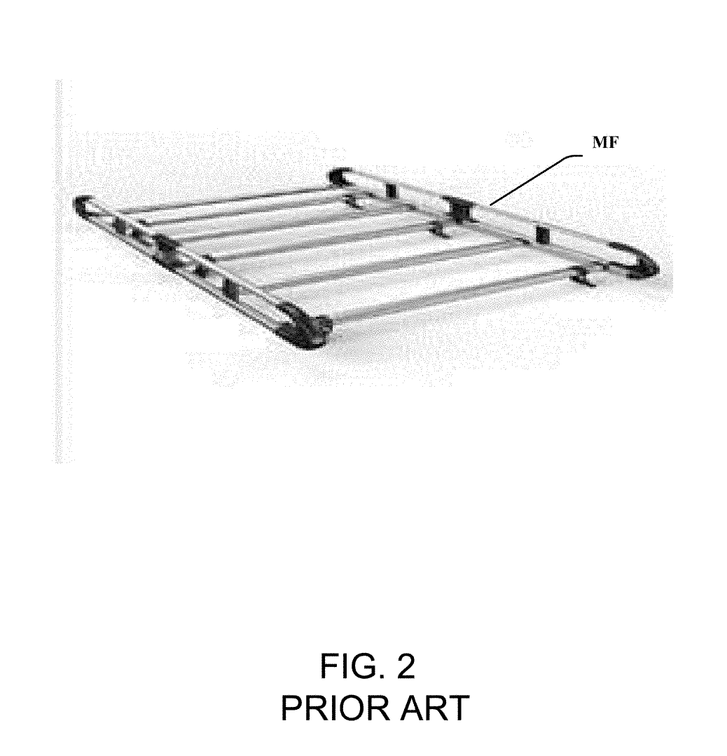

In one embodiment, the materials of the roof rack assembly 10 are configured to be structurally sufficient to support cargo on the vehicle during travel while the total weight of the roof rack assembly 10 is between about 15 pounds to 20 pounds (6.8 kg to 9.1 kg) less than the existing metal frame roof rack MF of the prior art shown in FIG. 2.

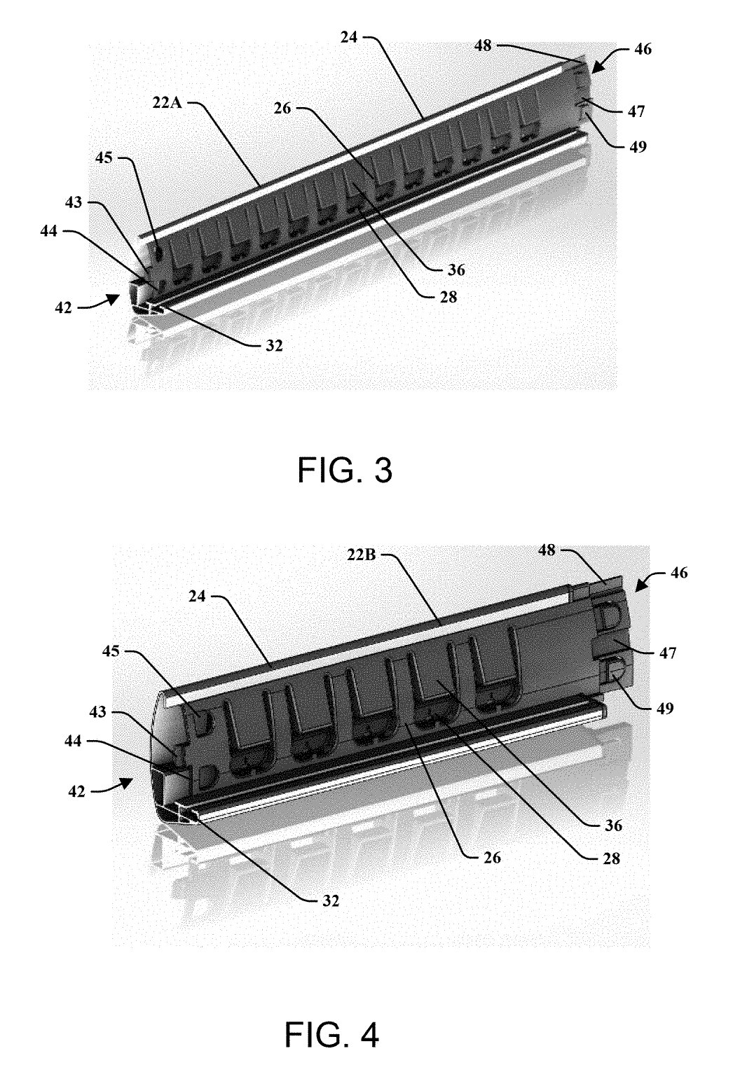

FIGS. 3 and 4 illustrate embodiments of a modular member of the rail members 20, 30. The first modular member 22A may have a first length per FIG. 3 and a second modular member 22B may have a shorter second length per FIG. 4. In one embodiment the first modular member 22A includes a length of between 3 feet to 4 feet or about 3.28 feet (1 meter) and the second modular emmer 22B includes a length between 1 feet and 2 feet or about 1.6 feet (0.49 meters). As illustrated by FIG. 1, the second rail member 30 includes two first modular members 22A with a second modular member 22B attached therebetween. However, the first and second rail members 20, 30 may include any combination of modular members 22A, 22B to customize the length of the rail members to properly fit with the roof of various types of vehicles as desired. The modular members 22A, 22B may be used interchangeably for both the first and second rail members 20, 30.

The modular members 22A, 22B may include an external portion 24 and an internal portion 26 wherein the internal portion 26 may be configured to be received by the external portion 24. The internal portion 26 may be an insert and the external portion 24 may be an extruded member. The inserts on internal portion 26 may be a molded polymer formed to be received within the external portion 24. The external portion 24 may be an extruded metal such as aluminum formed to receive the insert. However, the present teachings are not limited to this configuration. In other embodiments, the insert may be an extruded metal such as aluminum and the external portion 24 may be a molded polymer (or rubber, etc.).

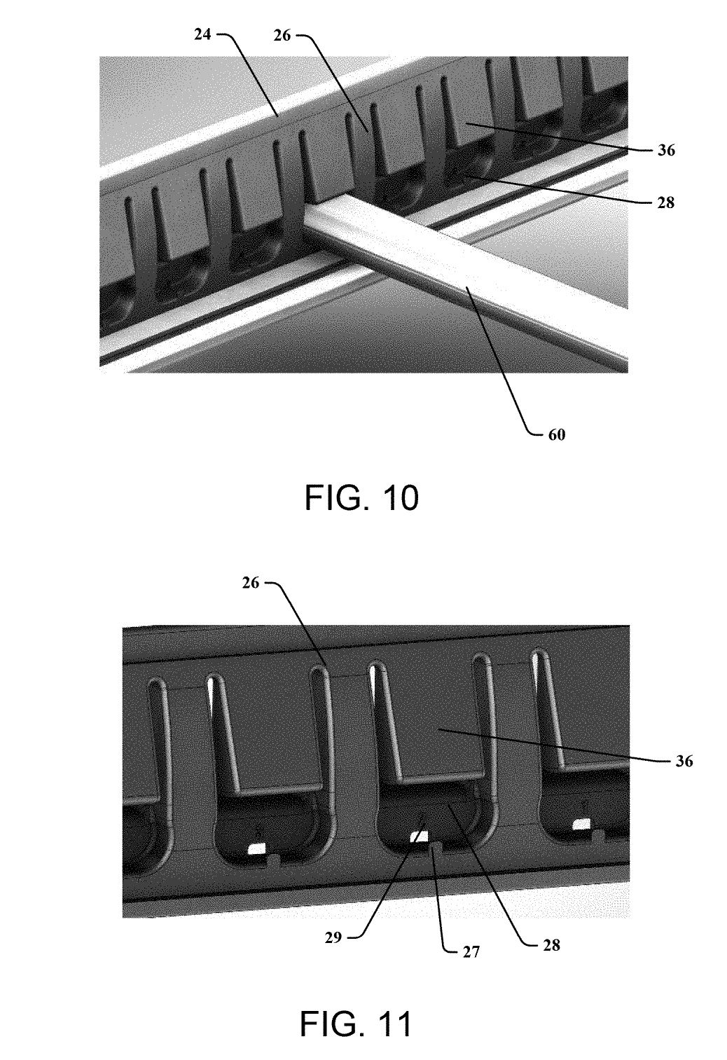

As illustrated by FIGS. 10 and 11, the insert on internal portion 26 may include a profile having a plurality of detents 28 shaped to receive an end of the cross beam 60 to be supported between the opposing rail members 20, 30. In one embodiment, the detents 28 may include a biasing member 36 that is configured to snap into place and lock the end of the cross beam 60 into place within the detent 28. The detents 28 and the inserts of both the first rail member 20 and the second rail member 30 may be aligned to allow cross bars 60 to be snap fit into position and maintain alignment with the front cross bar 40 and the rear cross bar 50. This allows for simple assembly and customized configurations. Notably, the support cross bars 60 may have a different length than the base cross bars 80. In one embodiment, the support cross bars 60 may have dimensions such as 50×25×1.5 FSO wherein the biasing member 36 may be configured to prevent removal of the support cross bars 60 unless the entire rail member 20, 30 is removed. As illustrated by FIG. 11, each detent 28 may include a nodule 27 that extends therefrom to provide lateral support to the support cross bars 60. Additionally, indicia 29 may be provided along the inserts on internal portion 26 to allow an installer to simplify assembly of the cross bars 60 to ensure alignment and avoid unintentional angular fitment. In one embodiment, the indicia 29 includes numbered positions such as 1, 2, 3, 2, 1 along the length of the insert on internal portion 26 to continue to match with the indicia 29 along the insert 26 of the opposite rail.

Turning to FIGS. 3 and 4, the insert 26 may include a first end 42 and an opposing second end 46 wherein the first end 42 includes a first attachment end 44 and the second end 46 includes a second attachment end 48. The first attachment end 44 may be configured to attach to the second attachment end 48 of another insert 26 or cap member and the second attachment end 44 may be configured to attach to the first attachment end 44 of another insert or cap member. The first and second attachment ends 44, 48 may be male/female type snap fit profiles wherein the first attachment end 44 may be configured to receive and be selectively attached to the second attachment end 48. Alternatively, the second attachment end 48 may be configured to receive and be selectively attached to the first attachment end 44. As illustrated by FIGS. 3 and 4, the first attachment end 44 may include a tongue 43 and a pair of apertures 45 and the second attachment end 48 may include a channel 47 and a pair of biasing members 49. The tongue 43 may be configured to be aligned with and slidingly received within the channel 47 while the biasing members 49 may be aligned to be selectively received within the apertures 45.

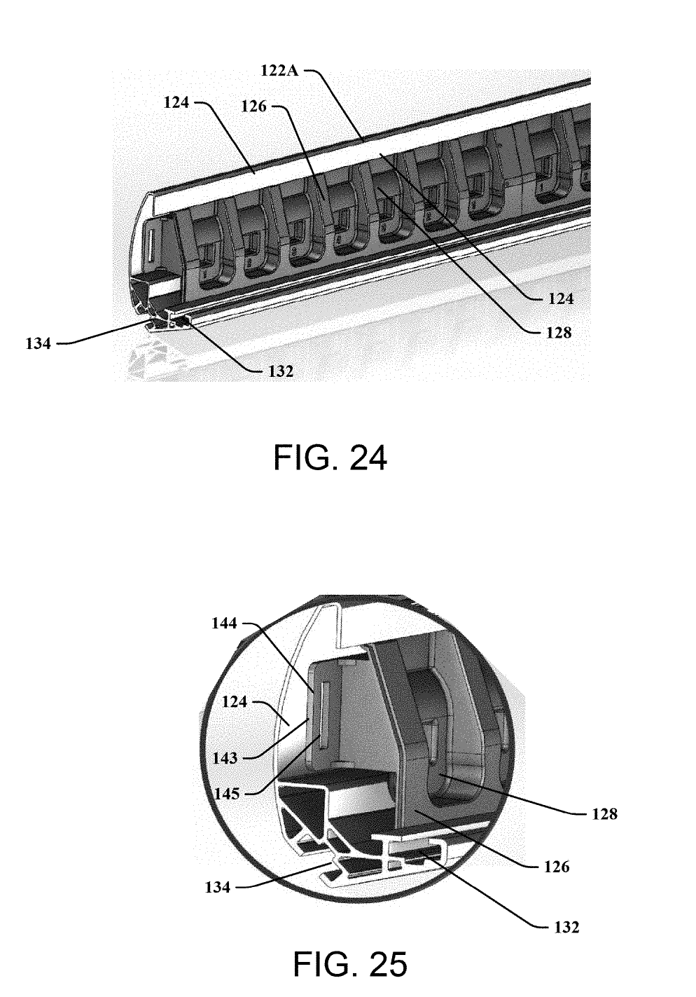

The rail members 20, 30 may include an internal track 32 accessible from between the opposing rail members 20, 30 as illustrated by FIGS. 3 and 4. Additionally, in one embodiment, the rail members 20, 30 may include an external track 34 accessible from the exterior of the roof rack assembly 10 as illustrated by FIGS. 24 and 25. The internal track 32 may be configured as a unitary, monolithic construction with the extruded member 24 and be configured to receive and selectively attach to an attachment member 70 (FIG. 8) along the end portion of the cross bar 60.

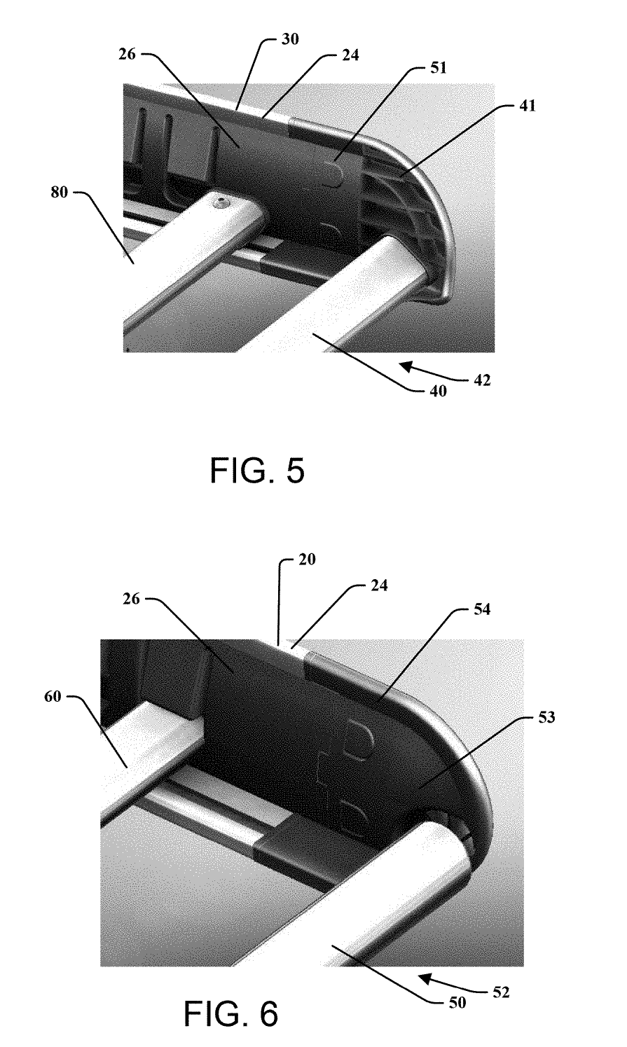

FIG. 5 illustrates the front portion 42 of the second rail member 30 wherein a front cap member 41 is attached to the insert 26 and external member 24. The front cap member 41 may include a recess profile configured to receive an end of the front cross bar 40. Notably, the front cross bar 40 may include an angled profile or may include a cross-sectional profile with a generally aerofoil shape. An opposite handed front end cap may be attached to the first rail member 20 opposite the front cap member 41 of the second rail member 30 such that the front cross bar 40 may be attached thereon and extend between the rail members 20, 30. The front cross bar 40 may be generally perpendicular to the rail members 20, 30. The front cap member 41 may also include an attachment end 51 configured to be selectively attached to either the first attachment end 44 or second attachment end 48 of the insert 26.

FIG. 6 illustrates the rear portion 52 of the first rail member 20 wherein a rear cap member 53 is attached to the insert 26 and external member 24. The rear cap member 53 may include a recess profile configured to receive an end of the rear cross bar 50. Notably, the rear cross bar 50 may include a generally circular cross sectional profile or may also include cross-sectional profile(s) with various polygon shapes. In one embodiment, the rear cross bar 50 may be a full width roller configured to rotate relative to the rear cap members 53. An opposite handed rear end cap may be attached to the second rail member 30 opposite the rear cap member 53 of the first rail member 20 such that the rear cross bar 50 may be attached thereon and extend between the rail members 20, 30. The assembled rear cross bar 50 may be generally perpendicular to the rail members 20, 30. The rear cap member 53 may also include an attachment end 54 configured to be selectively attached to either the first attachment end 44 or second attachment end 48 of the insert 26.

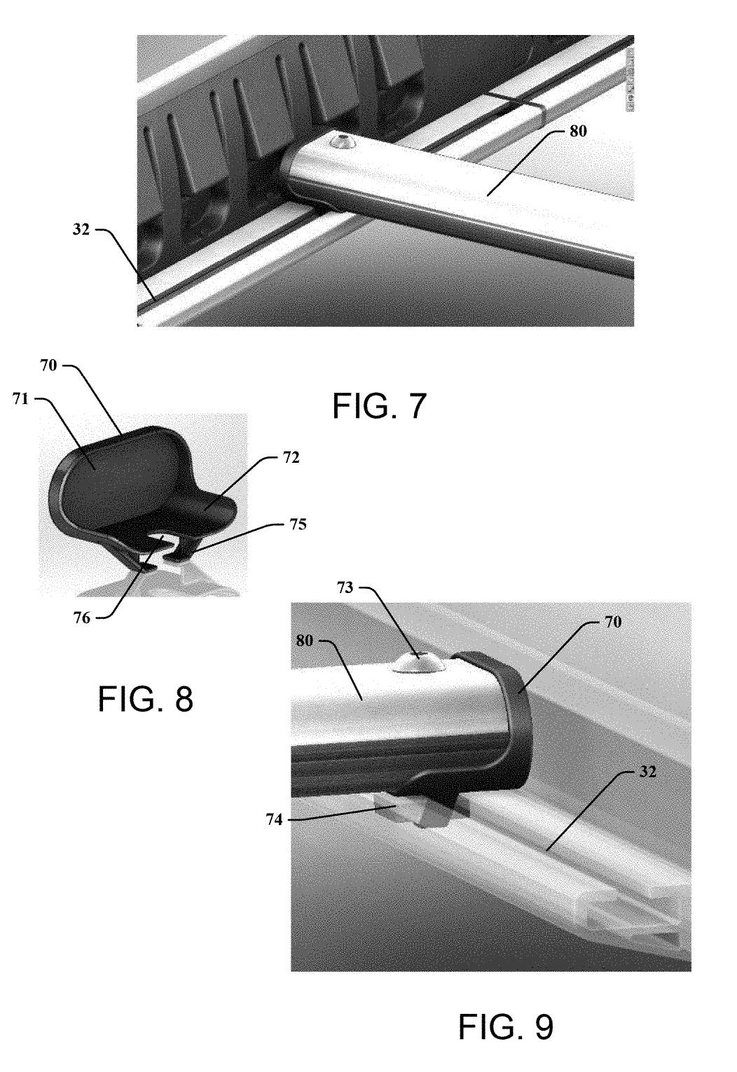

FIGS. 7, 8, and 9 illustrate the attachment member 70 attached between the base cross bar 80 and the internal track 32 along the rail member 20. The attachment member 70 may include an end cap 71 that covers the end of the base cross bar 80 extending from a cradle 72 for supporting the base cross bar 80. The attachment member 70 may include a protrusion member 74 that extends from the cradle 72 and is configured to be received within the internal track 32 to slidingly move along with the cross bar 80 and attachment member 70. A fastener 73 may be provided to selectively attach the base cross bar 80 and attachment member 70 to the internal tract 32. The protrusion member 74 may be a retaining nut wherein a pair of arms 75 may extend from the cradle 72 and support the retaining nut 74 in alignment with a cutout 76 along the cradle 72. The fastener 73 may extend through the cross bar 80 and cutout 76 and be received by the retaining nut held in protrusion 74 such that rotation of the fastener may loosened or tightened the retaining nut 74 relative to the track 32 to allow the cross bar 80 to be located in position relative to the rail members 20, 30 and vehicle for assembly thereon. This configuration having an attachment member allows for customizable positioning of the cross bars, while also allowing for the rail members 20, 30 to be held in position before additional cross bars and attachment member are selectively attached in place. Further, the attachment member 70 provides insulation between the cross bar 80 and track 32 to reduce galvanic reactions between metals.

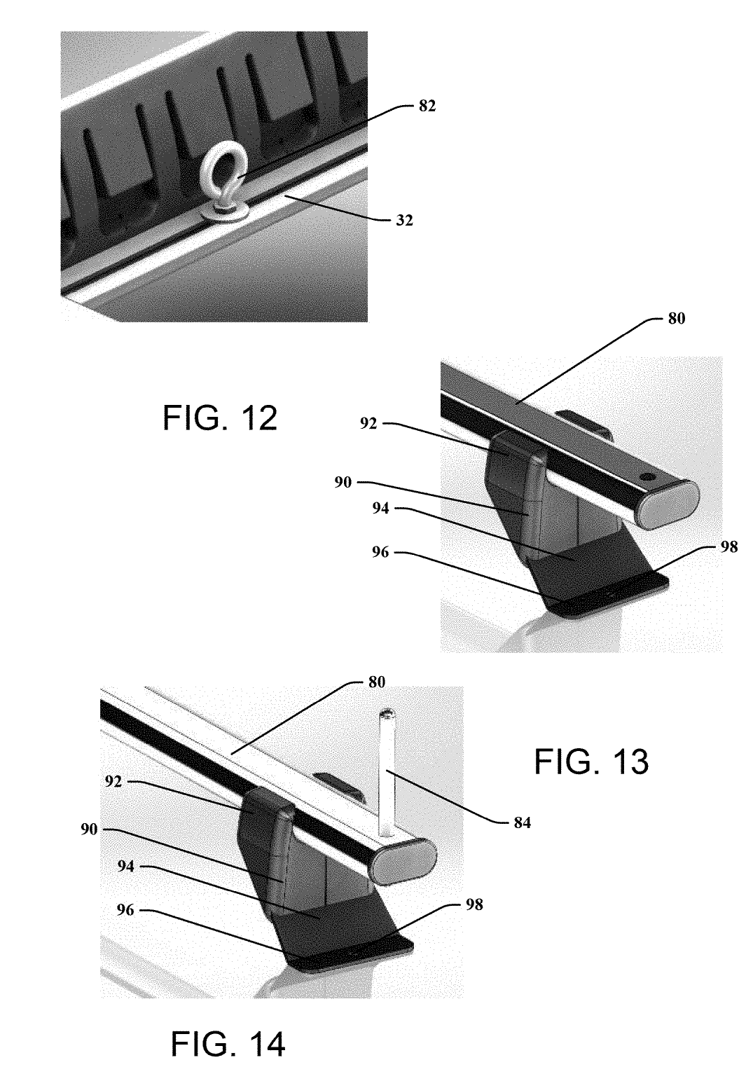

FIG. 12 illustrates an accessory 82 attached to the track 32 of the rail member. The roof rack assembly 10 may allow for various accessories to be slidingly received within the track 32 and be attached thereon. The accessory 82 of FIG. 12 is an eye hook which is merely one such example and the present teachings are not limited to such example—any appropriate accessory may be attached.

FIGS. 13 and 14 illustrate embodiments of a foot attachment member 90 configured to attach the base cross bar 80 to the vehicle. The foot attachment member 90 may include a receiving portion 92 for slidingly attaching to the base cross bar 90 and a support member 94 that extends from the receiving portion 92 and having a platform 96 for abutting against the vehicle. The platform 96 may include an aperture 98 for receiving a fastener to attach the foot attachment member 90 to the vehicle. As illustrated by FIG. 14, the base cross bar 80 may include a load stop 84 in place of the fastener 73. The base cross bars 80 and foot attachment member 90 may be assembled to the vehicle without the rail members 20, 30 and the load stop 84 may be placed along the ends of each base cross bar to retain cargo thereon.

This disclosure includes a method of attaching the roof rack assembly 10 to the vehicle. The steps include attaching the base cross bars 80 and foot attachment members 90 to the vehicle. The first and second rail members 20, 30 are assembled wherein the extruded portion 24 receives the insert 26 and the modular members 22A, 22B are attached to one another to create a desired length. The rear caps 53 and front caps 41 are attached to the first and second rail members 20, 30. The interior tracks 32 of the first and second rail members 20, 30 are positioned relative to the base cross bars 80 such that the interior tracks 32 receive the attachment members 70 therein. The rear cross bar 50 and front cross bar 40 are attached to the rear caps 53 and front caps 41, respectively. The fasteners 73 of the attachment members 70 can be selectively tightened to the tracks. Support cross bars 60 may be positioned against the inserts such that each cross bar 60 may be snapped into place as desired.

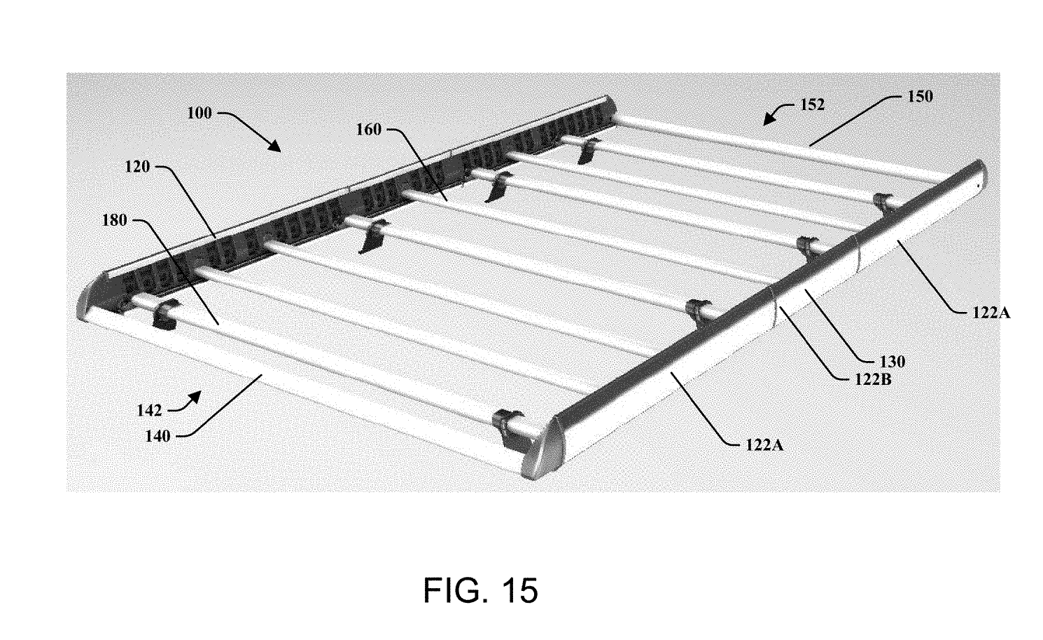

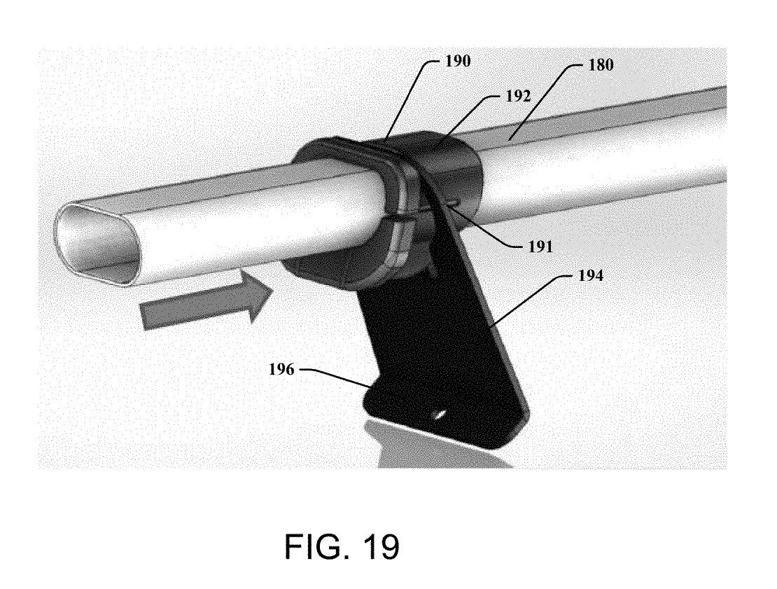

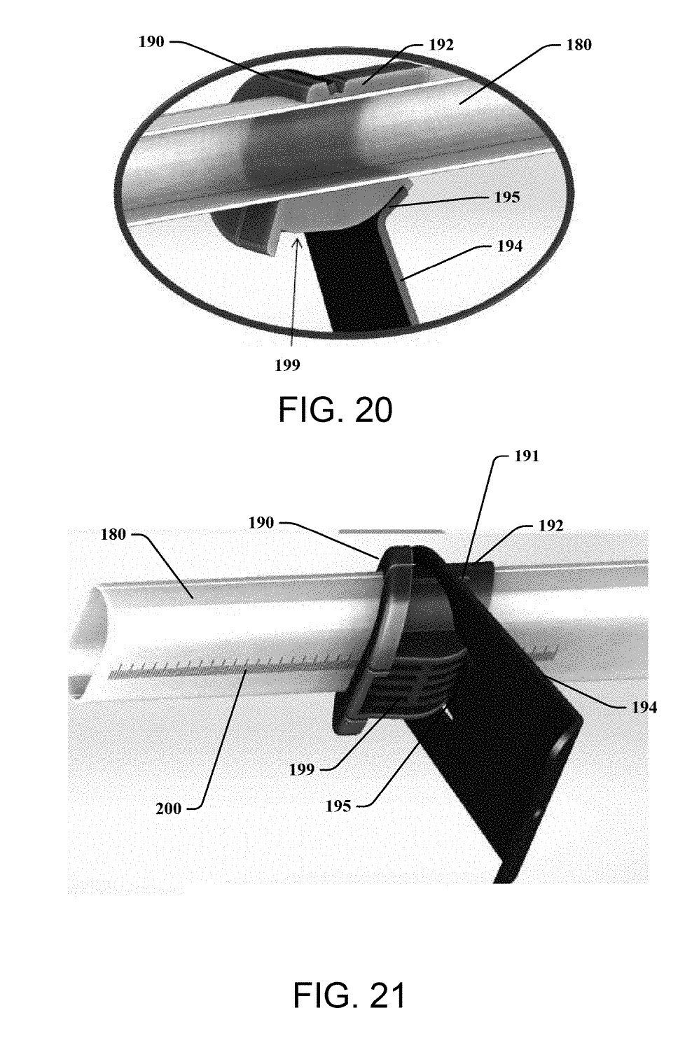

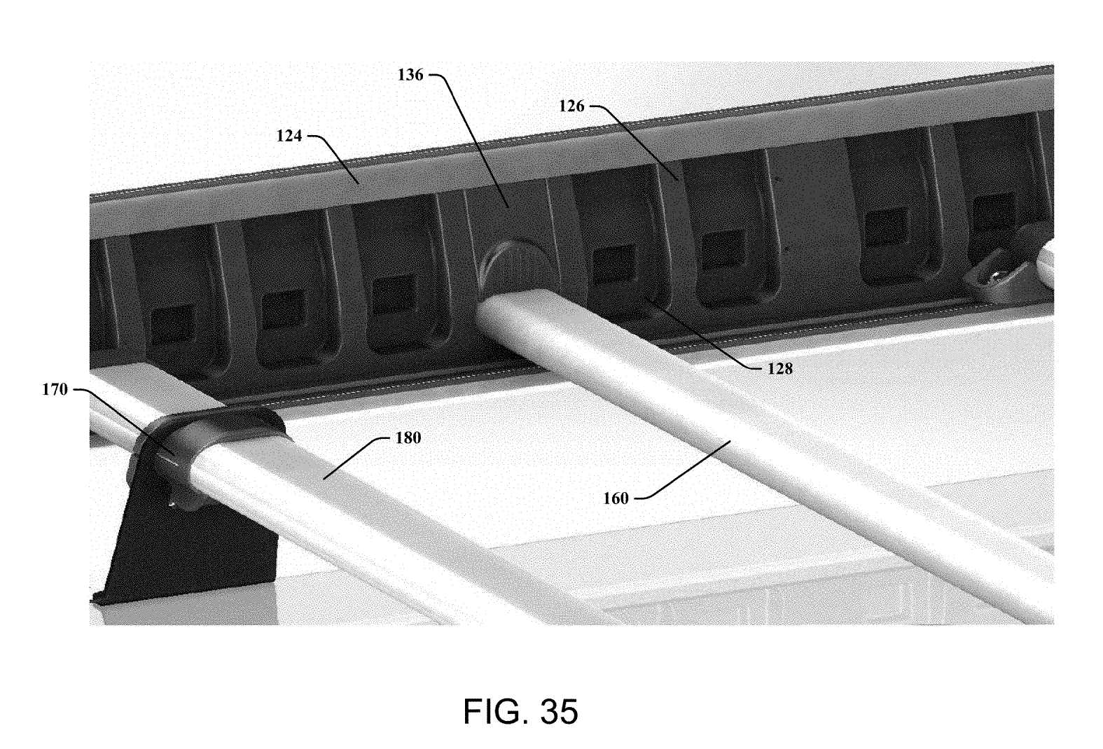

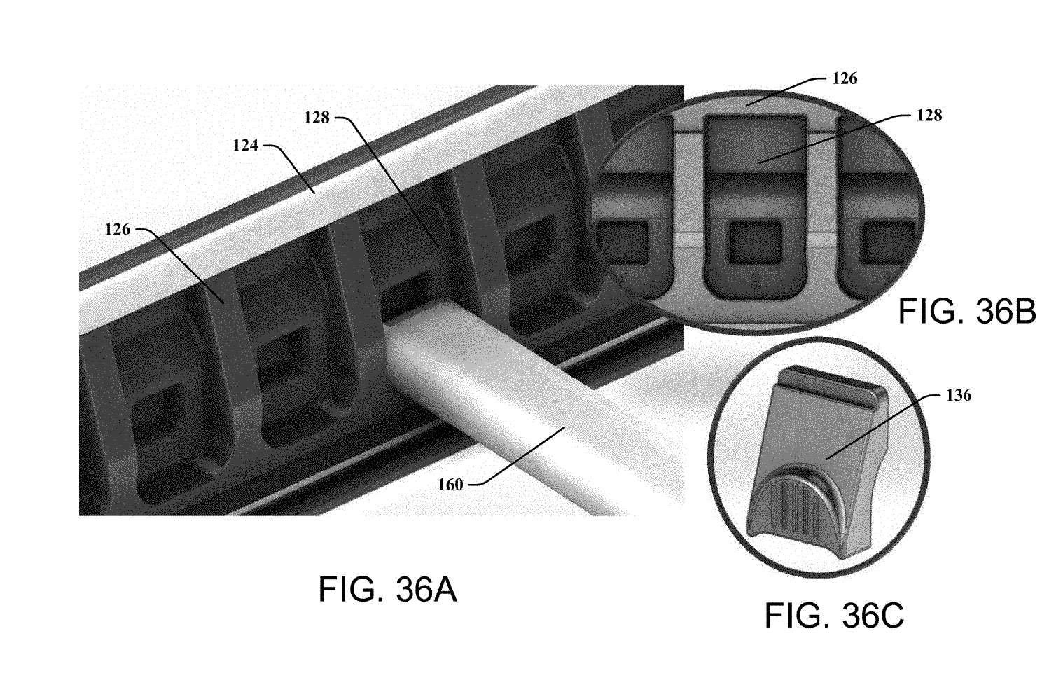

As illustrated by FIGS. 15-38B, provided are embodiments of a roof rack assembly 100 configured to be selectively attached to a vehicle. The roof rack assembly 100 includes similar features to the embodiments of the roof rack assembly 10 described above wherein similar reference numbers may be incorporated to describe similar features. The roof rack assembly 100 includes a generally modular configuration that is easy to transport and store separate from the vehicle and efficient to customize and assemble to the vehicle as will be described below.

The roof rack assembly 100 includes a first rail member 120 and an opposing second rail member 130. The first rail member 120 may be generally aligned with the second rail member 130 and be customizable in various configurations. The first and second rail members 120, 130 may be spaced apart from one another in a generally parallel orientation.

The first and second rail members 120, 130 may have a common length to one another. Additionally, the first and second rail members 120, 130 may each have a modular configuration wherein each rail member includes at least one modular member configured to be attached in alignment.

A front cross bar 140 may extend between the rail members 120, 130 along a front portion 142 and a rear cross bar 150 may extend between the rail members 120, 130 along a rear portion 152. The roof rack assembly 100 may be configurable to include at least one support cross bar 160 to extend from the first rail member 120 to the second rail member 130 and at least one base cross bar 180 to extend from the first rail member 120 to the second rail member 130. Notably, the support cross bars 160 may be configured to support cargo on the roof rack assembly 100 and the base cross bars 180 may be configured to attach the roof rack assembly 100 to the vehicle. Their may be a plurality of support cross bars 160 that may support the cargo and provide space between the cargo and the vehicle. The support cross bars 160 and base cross bars 180 may be attachable to the rail members 120, 130 in various ways. The front, rear, support, and base cross bars may be generally aligned along a common plane to support cargo thereon.

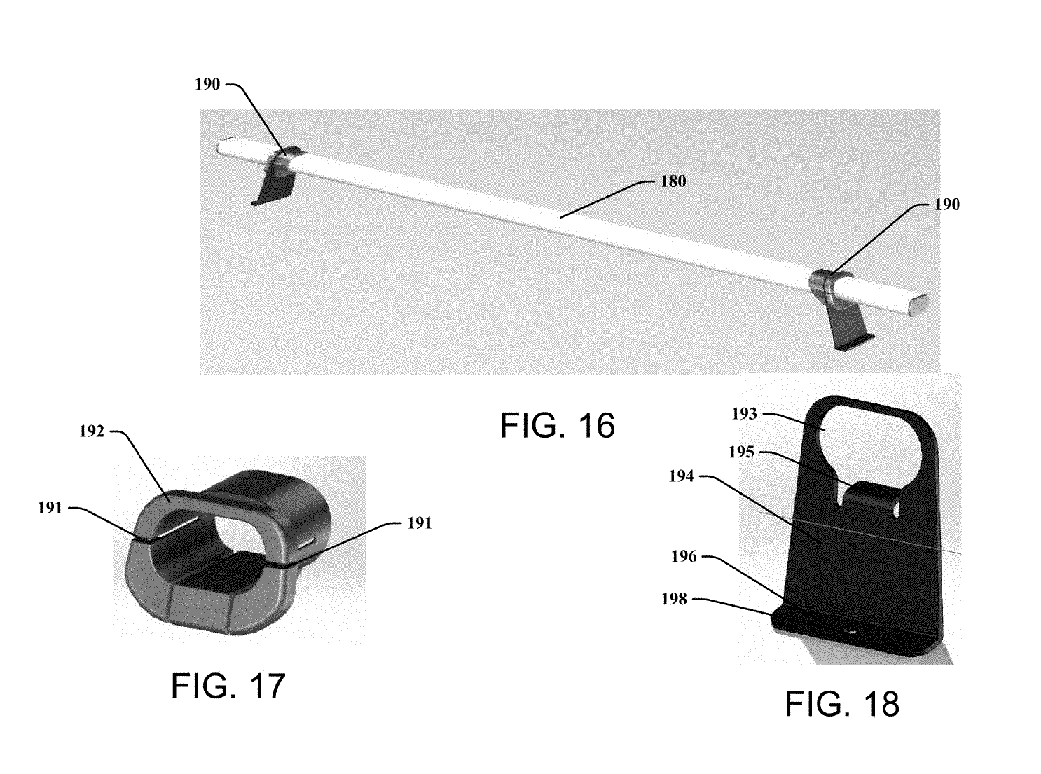

FIGS. 16-23 illustrate an embodiment of a foot attachment member 190. The foot attachment member 190 may be configured to attach the base cross bar 180 to the vehicle. The foot attachment member 190 may include a sleeve 192 for slidingly attaching to the base cross bar 190. The sleeve 192 may be made from a metal, alloy or polymer material and include slots 191 along either side thereof to allow the sleeve 192 to be compressed against a perimeter of the cross bar 180 or to be loosened to allow the sleeve 192 to be slidingly positioned along the length of the cross bar 180. A support panel 194 includes an aperture 193 that may receive the sleeve 192 therein and a biasing member 195 such that the support panel 194 may be biased between an open and a closed position relative to the sleeve 192. The support panel 194 may include a platform 196 for abutting against the vehicle. The platform 196 may be made from a metal, alloy or polymer material and may include an aperture 198 for receiving a fastener to attach the foot attachment member 190 to the vehicle. As illustrated by FIGS. 19, 20, and 21, the foot attachment member 190 is received along the base cross bar 180 wherein the sleeve 192 is positioned about the perimeter of the base cross bar 180 and received within the aperture 193 of the support panel 194. The support panel 194 is biased in the open position such that the sleeve 192 is loose relative to the base cross bar 180 and configured to slide along the length of the base cross bar 180. The sleeve 192 includes a cam profile 199 having a contour that abuts against the biasing member 195.

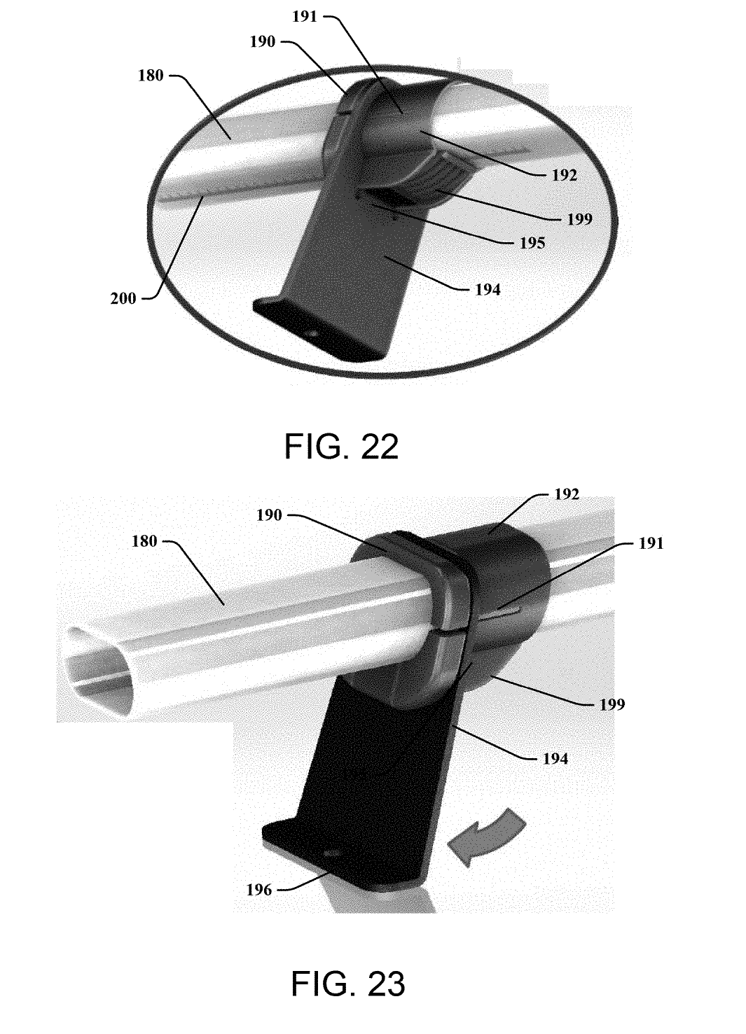

Once the sleeve 192 of the foot attachment member 190 is positioned in the desired place along the length of the base cross bar 180, the support panel 194 may be biased to a closed position as illustrated by FIGS. 22 and 23. When biasing the support panel between the open and closed positions, the bias member 195 pressed against the cam profile 199 and compressed the slots 191 of the sleeve 192 to snuggly tighten the sleeve 192 thereon. The platform 196 and support panel 194 may be aligned in the proper angle relative to the vehicle when the support panel 194 is biased in the closed position. Indicia 200 may be provided along the base cross bar 180 to assist a user with the proper placement of the foot attachment member 190 along either ends of the cross bar 180.

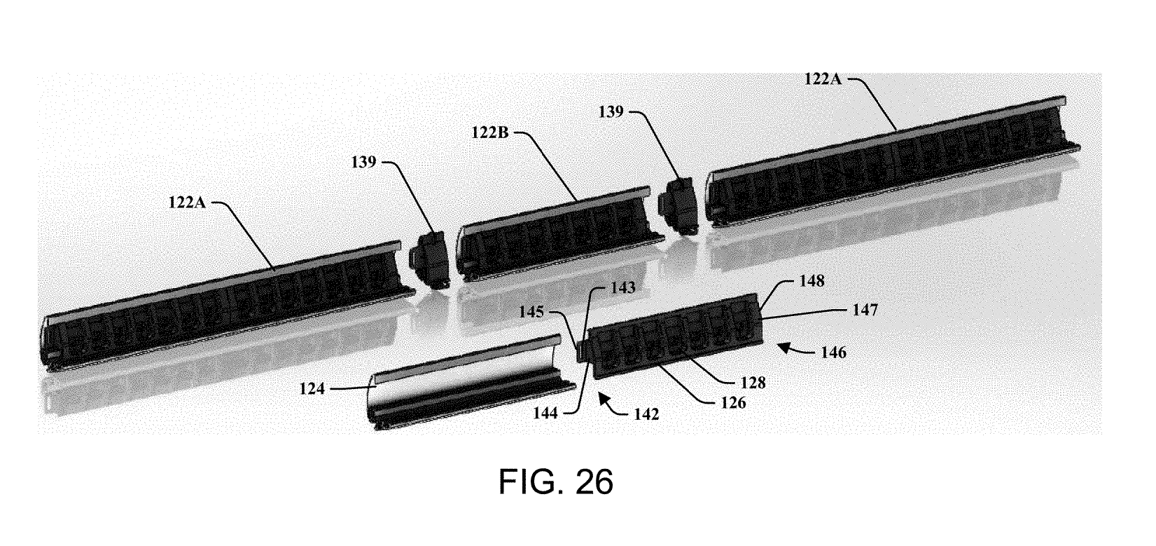

FIGS. 24 through 27B illustrate embodiments of a modular member of the rail members 120, 130. The first modular member 122A may have a first length and a second modular member 122B may have a shorter second length per FIG. 26. In one embodiment, the first modular member 122A includes a length of about 1030 mm and the second modular member 122B includes a length of about 510 mm. The first or second rail member 120, 130 may include two first modular members 122A with a second modular member 122B attached therebetween. However, the first and second rail members 120, 130 may include any combination of modular members 122A, 122B to customize the length of the rail members to properly fit with the roof of various types of vehicles as desired. The modular members 122A, 122B may be used interchangeably for both the first and second rail members 120, 130.

The modular members 122A, 122B may include an external portion 124 and an internal portion 126 wherein the internal portion 126 may be configured to be received by the external portion 124. The internal portion 126 include an insert and the external portion 124 may be an extruded member. The insert may be a molded polymer formed to be received within the external portion 124 while still presenting an inner facing. The external portion 124 may be an extruded metal such as aluminum formed to receive the insert of portion 126. Two inserts may be received within the extruded member 124 of modular member 122A while single insert may be received within the extruded member 124 of modular member 122B.

As illustrated by FIGS. 24-26, and 35-37C the insert formed on internal portion 126 may include a profile having a plurality of detents 128 shaped to receive an end of the support cross beam 160 to be supported between the opposing rail members 120, 130. In one embodiment, the detents 128 may be configured to receive a retainer member 136 that is configured to snap into place and lock the end of the cross beam 160 into place within the detent 28. The detents 128 of the inserts on internal portion 126 of both the first rail member 120 and the second rail member 130 may be aligned to allow cross bars 160 to be positioned in alignment with the front cross bar 140 and the rear cross bar 150. This allows for simple assembly and customized configurations. Notably, the support cross bars 160 may have a different length than the base cross bars 180. In one embodiment, the support cross bars 160 may have dimensions such as 50×25×1.5 mm wherein the retaining member 136 may be configured to prevent removal of the support cross bars 160 unless the entire rail member 120, 130 is removed. Indicia 129 may be provided along the inserts to allow an installer to simplify assembly of the cross bars 160 to ensure alignment and avoid unintentional angular fitment.

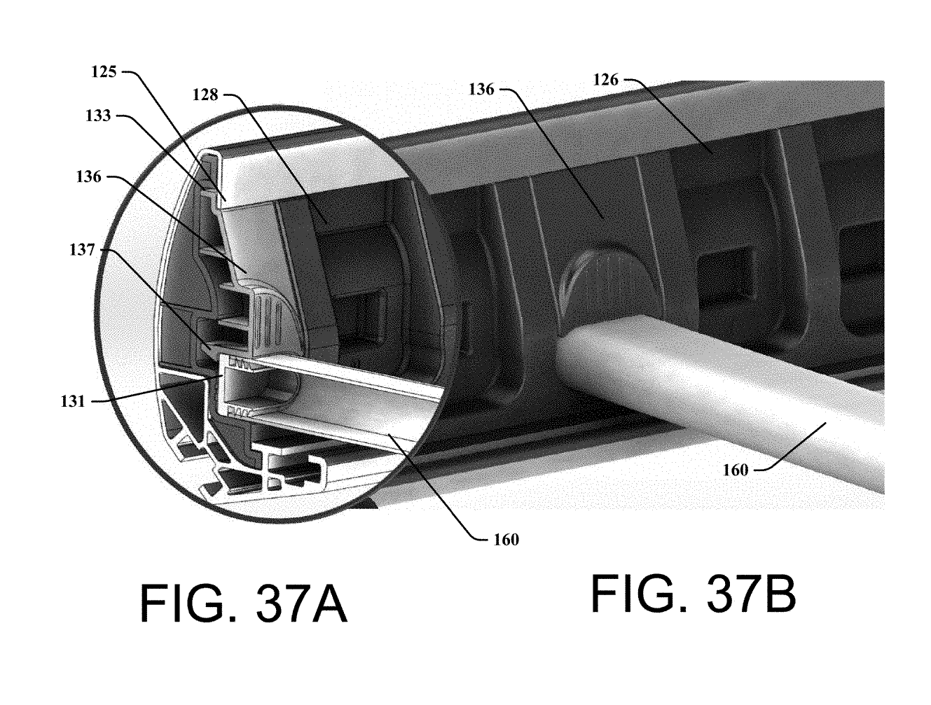

FIGS. 37A and 37B illustrate the attachment of the support cross bar 160 within the detents 128 of the inserts on internal portion 126. FIG. 37A illustrates the retainer member 136 as it is positioned within the detent 128 to lock the cross bar 160 therein. The retainer member 136 including a top shoulder 133 to be positioned behind a return 125 of the extruded portion 124 and a bottom shoulder 137 configured to be positioned along an end 131 of the support cross bar 160. When attaching the retainer member 136, the top shoulder 133 may first be positioned behind the return 125 of the extruded portion 124. The bottom shoulder 137 may then be biased against the support cross bar 160 to snap in place along the end of the cross bar 160.

Turning to FIG. 26, the insert forming internal portion 126 may include a first end 142 and an opposing second end 146 wherein the first end 142 includes a first attachment end 144 and the second end 146 includes a second attachment end 148. The first attachment end 144 may be configured to attach to the second attachment end 148 of another insert for internal portion 126 or front/rear cap member and the second attachment end 144 may be configured to attach to the first attachment end 144 of another insert or front/rear cap member. The first and second attachment ends 144, 148 may be male/female type snap fit profiles wherein the first attachment end 144 may be configured to receive and be selectively attached to the second attachment end 148. Alternatively, the second attachment end 148 may be configured to receive and be selectively attached to the first attachment end 144. As illustrated by FIG. 25, the first attachment end 144 may include a tongue 143 and an aperture 145 and the second attachment end 148 may include a channel 147 and a snap-fit member 149. The tongue 143 may be configured to be aligned with and slidingly received within the channel 147 while the snap-fit member 149 may be aligned to be selectively received within the aperture 145.

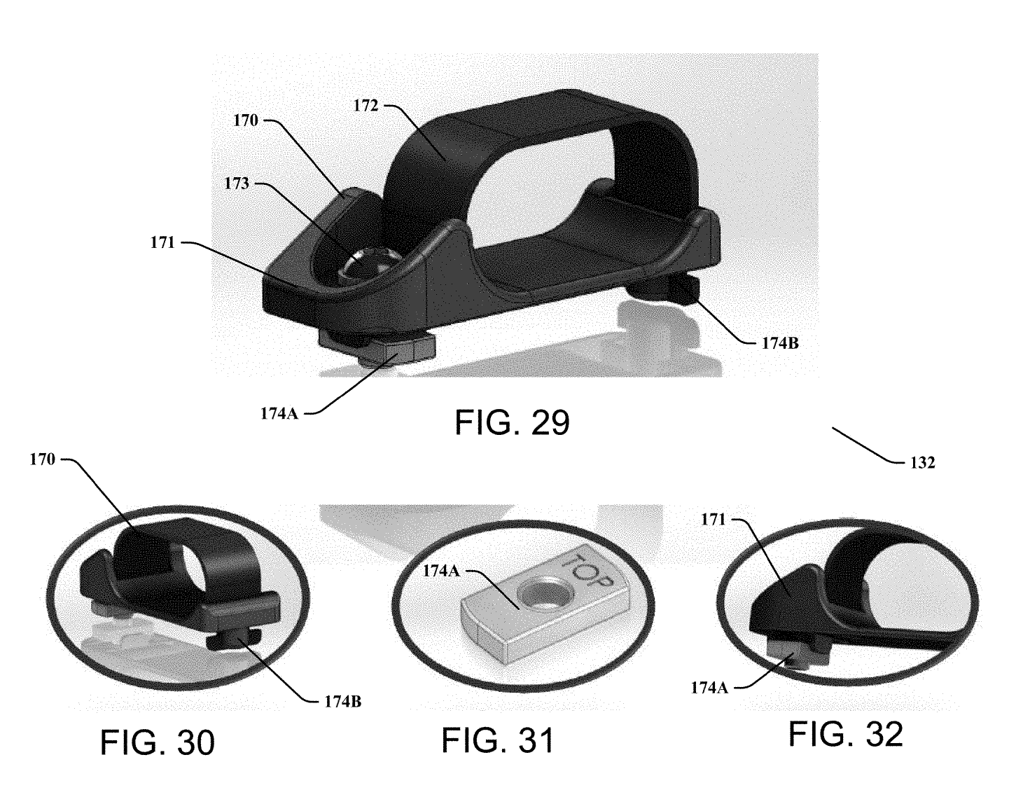

The rail members 120, 130 may include an internal track 132 accessible from between the opposing rail members 120, 130 as illustrated by FIGS. 3 and 4. The internal track 132 may be configured as a unitary construction with the extruded member 124 and be configured to receive and selectively attach to an attachment member 170 (FIG. 29) along the end portion of the base cross bar 180. Additionally, the rail members 120, 130 may include an external track 134 accessible from the exterior of the roof rack assembly 100 as illustrated by FIGS. 24 and 25.

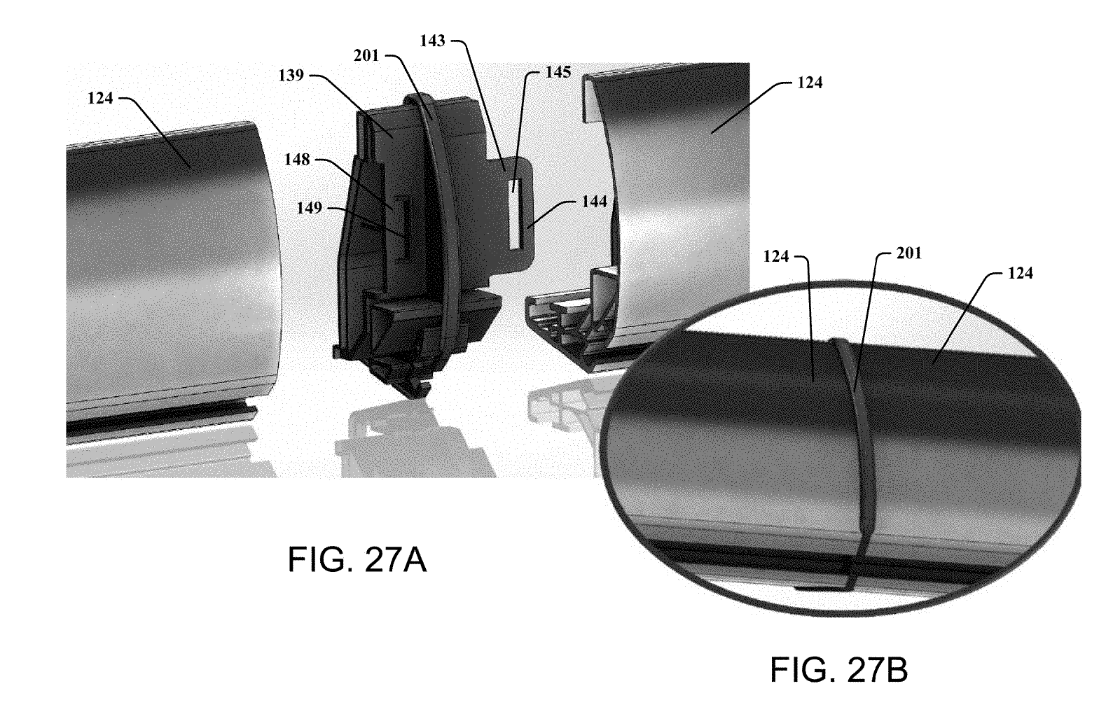

As illustrated by FIGS. 26, 27A, and 27B, a coupling 139 may include similar attachment features as the first and second ends 144, 148 of the inserts on internal portion 126. The coupling 139 may be configured to attach the first modular members 122A with the second modular members 122B while maintaining the continuity of the internal and external tracks 132, 134 along the lengths of the rail members 120, 130. The coupler 139 may additionally include a perimeter edge 201 that extends about the perimeter of the coupler 139 and abuts and aligns extruded portions 124 of the modular members 122A, 122B.

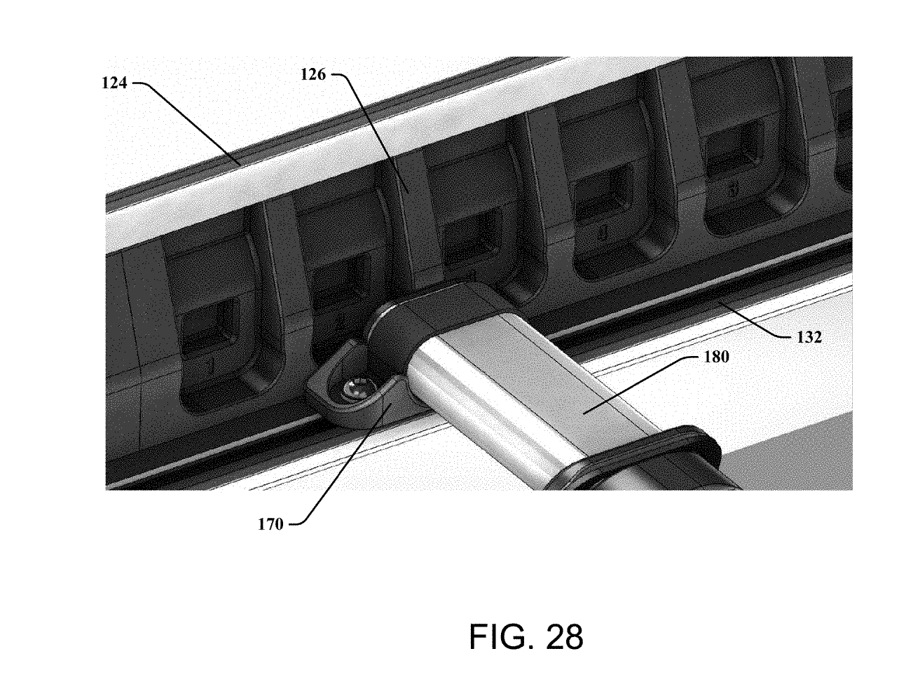

FIGS. 28-32 illustrate the attachment member 170 configured to be attached between the base cross bar 180 and the internal track 132 along the rail members. The attachment member 170 may include a saddle body 171 that supports the end of the base cross bar 180. A strap member 172 may extend from a saddle body 171 and surround the perimeter of the base cross bar 180 to clamp the base cross bar 180 therebetween. The attachment member 170 may include a first protrusion member 174A that extends from the saddle body 171 and is configured to be received within the internal track 132 to slidingly move along with the cross bar 180 and attachment member 170. A second protrusion member 174B may extend from the saddle body 171 opposite from the first protrusion member 174A and also be configured to be received within the internal track to slidingly move along the base cross bar 180.

A fastener 173 may be provided to selectively attach the base cross bar 80 and attachment member 170 to the internal track 132. The protrusion member 174A may be a retaining nut wherein the second protrusion member may be a T-shaped body. The fastener 173 may extend through the saddle body 171 and attach to the retaining nut 174A. The attachment member 170 may be attached to the track 132 by inserting the second protrusion member 174B and rotating the saddle body 171 about 90 degrees to along the T-shaped body to align within the track 132. The retaining nut 174A may have a general rectangular shape and be configured to fit lengthwise within the track 132 such that rotation of the fastener 173 may position the retaining nut 174A in retained alignment with the track 132. The fastener 173 may extend through the saddle body 171 and be received by the retaining nut 174A such that rotation of the fastener may loosened or tightened the retaining nut 174 relative to the track 132 to allow the cross bar 180 to be located in position relative to the rail members 120, 130 and vehicle for assembly thereon. This configuration allows for customizable positioning and allows for the rail members 120, 130 to be held in position before the cross bar 180 and attachment member 170 are selectively attached in place. Further, the attachment member 170 provides insulation between the cross bar 180 and track 132 to reduce galvanic reactions between metals.

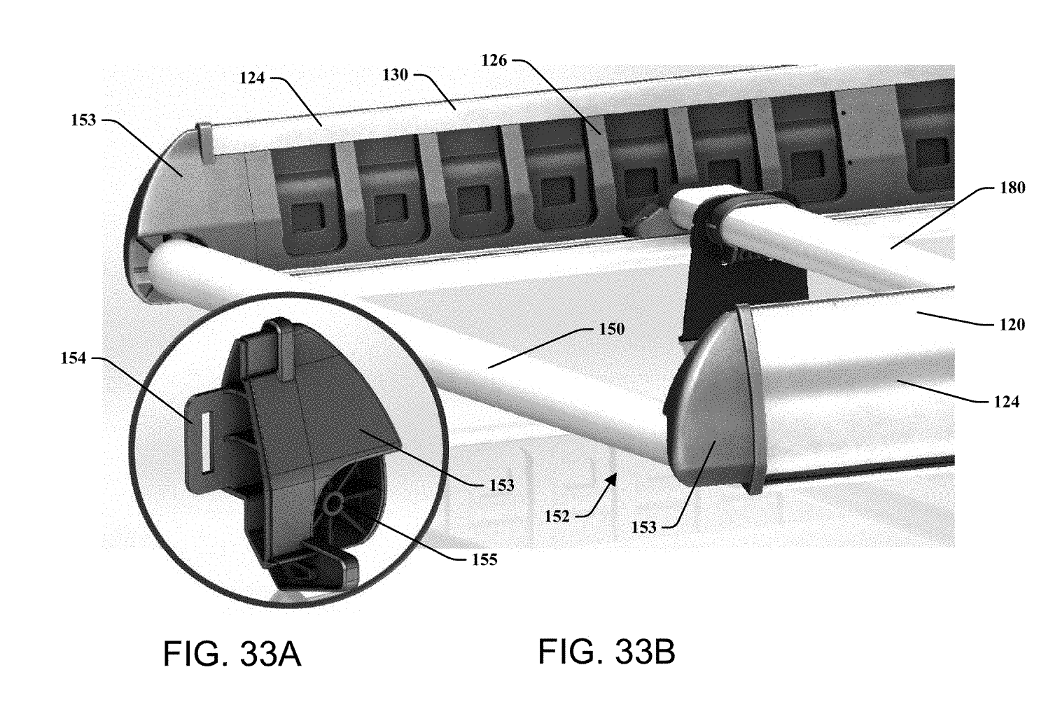

FIGS. 33A and 33B illustrate the rear portion 152 of the roof rack assembly 100 wherein rear cap members 153 is attached to the inserts on internal portion 126 and extruded portions 124 of the rail members. The rear cap member 153 may include a recess profile 155 configured to receive an end of the rear cross bar 150. Notably, the rear cross bar 150 may include a generally circular cross sectional profile or may also include cross-sectional profile(s) with various polygon shapes. In one embodiment, the rear cross bar 150 may be a full width roller configured to rotate relative to the rear cap members 153. An opposite handed rear end cap may be attached to the second rail member 130 opposite the rear cap member 153 of the first rail member 120 such that the rear cross bar 150 may be attached thereon and extend between the rail members. The assembled rear cross bar 150 may be generally perpendicular to the rail members 120, 130. The rear cap member 153 may also include an attachment end 154 configured to be selectively attached to either the first attachment end 144 or second attachment end 148 of the insert associated with internal portion 126.

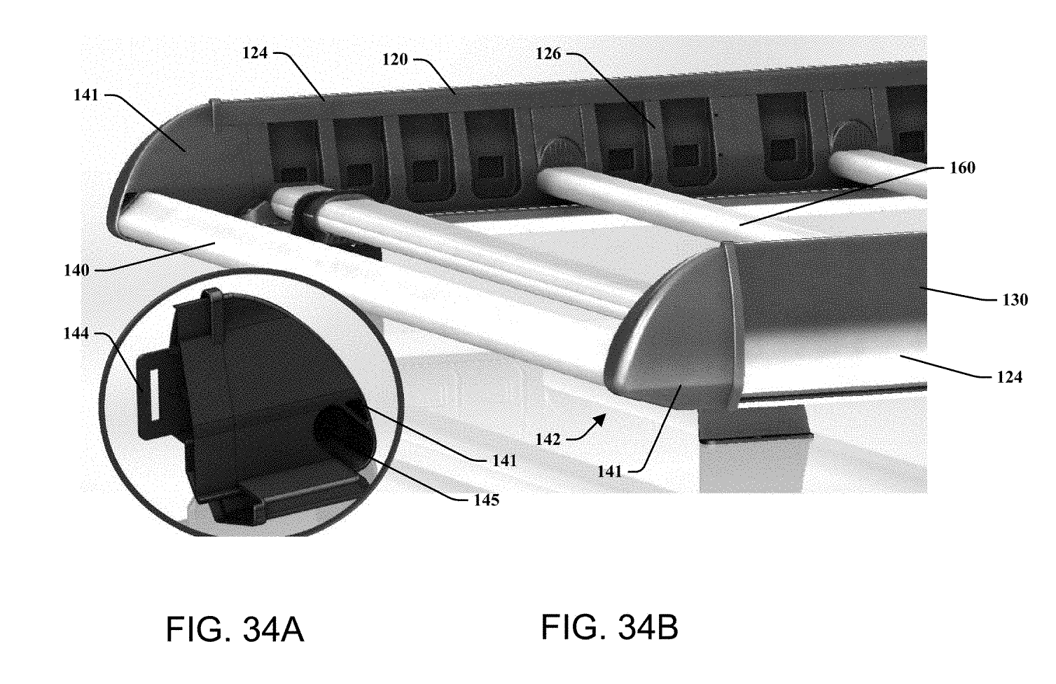

FIGS. 34A and 34B illustrates the front portion 142 of the roof rack assembly 100 wherein a front cap member 141 is attached to the inserts forming internal portion 126 and extruded portions 124 of the rail members. The front cap member 141 may include a recess profile 145 configured to receive an end of the front cross bar 140. Notably, the front cross bar 140 may include an angled profile or may include a cross-sectional profile with a generally aerofoil shape. An opposite handed front end cap 141 may be attached to the first rail member 120 opposite the front cap member 141 of the second rail member 130 such that the front cross bar 140 may be attached thereon and extend between the rail members. The front cross bar 140 may be generally perpendicular to the rail members 120, 130. The front cap member 141 may also include an attachment end 145 configured to be selectively attached to either the first attachment end 144 or second attachment end 148 of the insert comprising internal portion 126.

FIG. 12 illustrates an accessory 82 attached to the tract 32 of the rail member. The roof rack assembly 10 may allow for various accessories to be slidingly received within the track 32 and be attached thereon. The accessory 82 of FIG. 12 is an eye hook which is merely one such example

This disclosure includes a method of attaching the roof rack assembly 10 to the vehicle. The steps include attaching the base cross bars 80 and foot attachment members 90 to the vehicle. The first and second rail members 20, 30 are assembled wherein the extruded portion 24 receives the insert 26 and the modular members 22A, 22B are attached to one another to create a desired length. The rear caps 53 and front caps 41 are attached to the first and second rail members 20, 30. The interior tracks 32 of the first and second rail members 20, 30 are positioned relative to the base cross bars 80 such that the interior tracks 32 receive the attachment members 70 therein. The rear cross bar 50 and front cross bar 40 are attached to the rear caps 53 and front caps 41, respectively. The fasteners 73 of the attachment members 70 can be selectively tightened to the tracks. Support cross bars 60 may be positioned against the inserts on internal portion 26 such that each cross bar 60 may be snapped into place as desired.

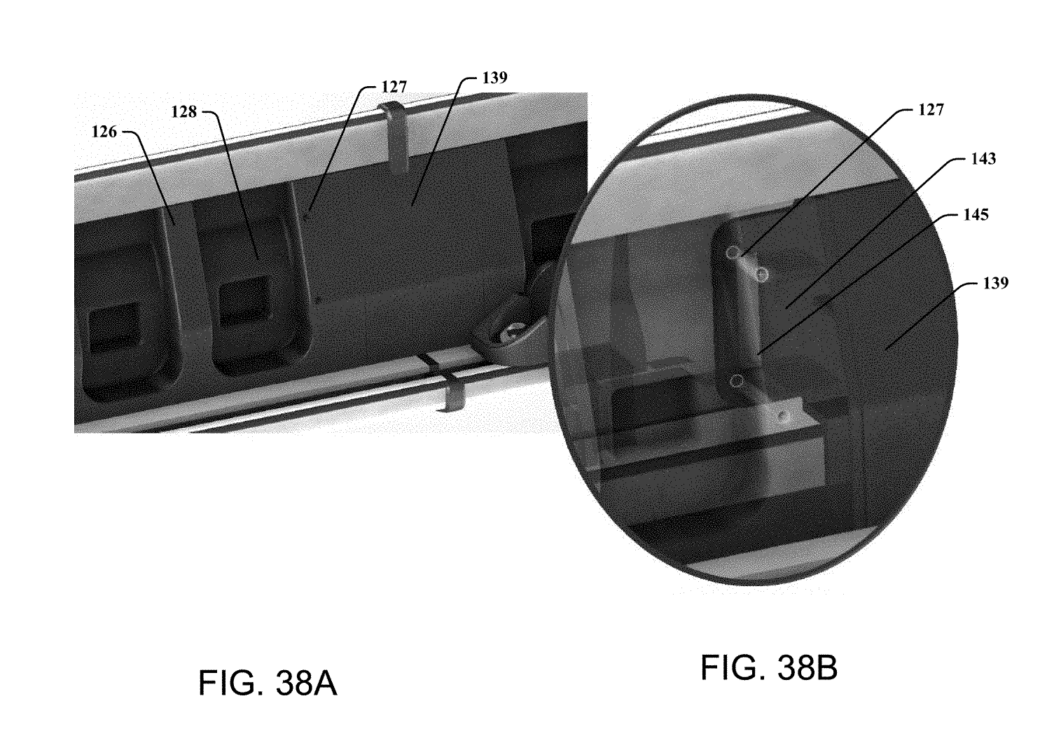

Turning to FIGS. 38A and 38B, the inserts on internal portion 126 may include at least one release hole 127 to allow access to the attachment portions between the inserts on internal portion 126 or couplers 139. The release holes 127 may allow a user to insert an elongated tool to press the tongue 143 to disengage the snap-fit member 149 from the aperture 145.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

1. A roof rack assembly for a vehicle comprising:
a first rail having an external facing, an internal facing having a series of detents formed thereon, and an internal track;
a second rail, spaced apart from the first rail, having an external facing, an internal facing having a series of detents formed thereon, and an internal track;
a cross bar having first and second ends, wherein the first end cooperates with one of the detents and the internal track of the first rail and the second end cooperates with one of the detents and the internal track of the second rail to secure the cross bar between the first rail and the second rail; and
a foot attachment member associated with the cross bar, wherein a top portion of the foot attachment member receives a portion of the cross bar at a point between the first and second ends.

2. The roof rack assembly according to claim 1, wherein the first rail further comprises a plurality of modular sections, each modular section of the first rail having an internal facing with a portion of the detents and a portion of the internal track formed thereon.

3. The roof rack assembly according to claim 2, wherein the second rail further comprises a plurality of modular sections, each modular section of the second rail having an internal facing with a portion of the detents and a portion of the internal track formed thereon.

4. The roof rack assembly according to claim 2, further comprising a coupling positioned between a pair of adjacent modular sections of at least one of: the first rail and the second rail.

5. The roof rack assembly according to claim 4, wherein the coupling includes at least one: a tongue, an aperture, a channel, a snap-fit member, and a peg.

6. The roof rack assembly according to claim 5, wherein the coupling is integrated into the pair modular sections of at least one of: the first rail and the second rail.

7. The roof rack assembly according to claim 1, further comprising a biasing member positioned proximate to each detent.

8. The roof rack assembly according to claim 1, wherein at least one of the detents includes a nodule.

9. The roof rack assembly according to claim 1, wherein a plurality of cross bars are provided and each cross bar is secured to the first rail and the second rail at a plurality of individual detents on each of the first rail and the second rail.

10. The roof rack assembly according to claim 1, further comprising at least one accessory received within the internal track of the first rail.

11. The roof rack assembly according to claim 10, wherein the at least one accessory comprises an eyelet.

12. The roof rack assembly according to claim 1, further comprising cross bar attachment members disposed at the first and second ends of at least one cross bar.

13. The roof rack assembly according to claim 12, wherein cross bar attachment members are disposed on the first and second ends of all of the cross bars.

14. The roof rack assembly according to claim 12, wherein at least one of the cross bar attachment members includes a protrusion received within the internal track of at least one of the first rail and the second rail.

15. The roof rack assembly according to claim 14, wherein at least one of the cross bar attachment members further includes a fastener.

16. The roof rack assembly according to claim 15, wherein the fastener passes through the first end of the cross bar and is received by the protrusion.

17. The roof rack assembly according to claim 12, wherein the cross bar attachment members comprise individual retainers fitted into individual detents on at least one of the first rail and the second rail.

18. The roof rack assembly according to claim 1, further comprising at least one end cap positioned on corresponding ends of the first rail and the second rail.

19. The roof rack assembly according to claim 18, wherein a plurality of end caps secure a third cross bar positioned between the first rail and the second rail.

20. The roof rack assembly according to claim 18, wherein the end caps are provided at both ends of each of the first rail and the second rail.

21. The roof rack assembly according to claim 18, further comprising a second coupling is positioned between at least one end cap and at least one of the first rail and the second rail.

22. The roof rack assembly according to claim 21, wherein the second coupling includes at least one: a tongue, an aperture, a channel, a snap-fit member, and a peg.

23. The roof rack assembly according to claim 22, wherein a plurality of second couplings are associated with each end cap.

24. The roof rack assembly according to claim 1, wherein the foot attachment member comprises a sleeve.

25. The roof rack assembly according to claim 1, wherein a pair of foot attachment members are provided to two separate cross bars, each of the two separate cross bars having first and second ends so that the first end cooperates with one of the detents and the internal track of the first rail and the second end cooperates with one of the detents and the internal track of the second rail to connect to the second rail to secure each cross bar between the first rail and the second rail at spaced apart locations.

26. A method of attaching a roof rack assembly to a vehicle, the method comprising:
attaching a pair of foot attachment members to two separate cross bars;
securing the foot attachment members to a vehicle rooftop;
coupling together modular sections to form a first rail having a series of detents and an internal track and second rail having a series of detents and an internal track;
connecting the first rail to the two separate cross bars by positioning an end of each cross bar within separate detents on the first rail; and
connecting the second rail to the two separate cross bars by positioning an opposing end of each cross bar within separate detents on the second rail.

27. The method according to claim 26, further comprising attaching a cross bar attachment members to opposing ends of each cross bar and fitting each cross bar attachment member within the internal tracks on both the first and second rails.

28. The method according to claim 26, further comprising attaching end caps to corresponding ends of the first and second rail and securing a third cross bar between the end caps.
